(19) United States
(12) Patent Application Publication
(10) Pub. No.: US 2010/0122284 A1
(43) Pub. Date: May 13, 2010

(54) BROADCASTING RECEIVER AND METHOD OF PROCESSING EMERGENCY ALERT MESSAGE

(75) Inventors: Chang Sik Yoon, Seoul (KR); Sung Deuk Cho, Seoul (KR)

Correspondence Address: MCKENNA LONG & ALDRIDGE LLP, 1900 K STREET, NW, WASHINGTON, DC, 20006, US

(73) Assignee: LG ELECTRONICS INC., Youngdungpo-gu (KR)

(21) Appl. No.: 12/310,685

(22) PCT Filed: Sep. 7, 2007
(86) PCT No.: PCT/KR2007/004352

§ 371 Date: Jan. 13, 2010

(30) Foreign Application Priority Data
Sep. 8, 2006 (KR) 10-2006-0086895
Sep. 8, 2006 (KR) 10-2006-0086896

(51) Int. Cl. H04N 7/025

(52) U.S. Cl. 725/33

(57) ABSTRACT

A broadcasting receiver capable of receiving cable broadcasting and a method of processing an emergency alert message thereof are disclosed. Each time an emergency alert message is received, each time an execution of a received emergency alert message such as a channel switching and/or a message display is needed, or each time an executed emergency alert message is terminated, a host within a broadcasting receiver according to the present invention provides each state information to a data broadcasting associated application within the broadcasting receiver. Accordingly, when a host executes an emergency alert message, it is able to prevent abnormal operations of a data broadcasting associated application.

### TECHNICAL FIELD

The present invention relates to a broadcasting receiver, and more particularly, to a method of processing an emergency alert message in an interactive broadcasting receiver capable of receiving cable broadcasting.

### BACKGROUND ART

Generally, a cable broadcasting system of digital broadcasting system consists of a cable broadcasting station as a transmitting side for transmitting cable broadcasting and a broadcasting receiver capable of receiving the transmitted cable broadcasting. And, the cable broadcasting station may be called a headend.

An open cable type broadcasting receiver adopted as a domestic standard can be mainly divided into a hardware part and a software part.

First of all, hardware consists of a set-top box and a cable card (CableCard) divided into a security function and a conditional access (CA) function from the set-top box. Thus, a function of facilitating a security system to be replaced is provided and retail sale of the set-top box is enabled. So, it is advantageous that an inexpensive cable broadcasting receiver can be supplied.

The cable card is called a POD (point of deployment) module and uses a PCMCIA card for example. And, a set-top box, in which the cable card is inserted, may be called a host. For instance, a digital built-in TV, a digital ready TV or the like corresponds to a host. And, the host and the cable card are combined to configure a cable broadcasting receiver as well.

Meanwhile, a data broadcasting associated application platform is the core of software in an open cable type broadcasting receiver. The data broadcasting associated application platform includes MHP (multimedia home platform), OCAP (open cable application platform), ACAP (advanced common application platform) or the like. IN particular, the OCAP is mounted for data broadcasting in an open cable type broadcasting receiver.

Namely, the OCAP is the standard that becomes an application production base for a cable type interactive data broadcasting service. In other words, the OCAP is a data broadcasting middleware standard for an interactive service in an open cable system. In this case, the open cable system leads the activation of contents industry in a manner of enabling application software and contents to be shared using a common middleware platform called OCAP.

### DISCLOSURE OF INVENTION

### Technical Problem

In a cable broadcasting system, a basic protocol for receiving and processing an emergency alert message which is transmitted by a transmitting side to be prepared for an emergency situation is regulated. In particular, if an emergency alert message is transmitted via a specific terrestrial or cable frequency, a host within a broadcasting receiver receives the corresponding emergency alert message. To provide information on emergency alert to a viewer watching a TV effectively, the host performs channel switching to an emergency broadcast channel and outputs the information on the emergency alert.

### Technical Solution

Accordingly, the present invention is directed to a broadcasting receiver and method of processing an emergency alert message that substantially obviate one or more of the problems due to limitations and disadvantages of the related art.

An object of the present invention is to provide a broadcasting receiver and method of processing an emergency alert message, by which an abnormal operation of a data broadcasting associated application can be prevented in case of executing an emergency alert message received by the broadcasting receiver.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a broadcasting receiver according to the present invention includes a data broadcasting associated application, a platform downloading and installing the data broadcasting associated application therein, and a host receiving an emergency alert message transmitted from a broadcasting station, wherein the host executes or terminates the emergency alert message in accordance with a content included in the received emergency alert message, wherein the host generates state information associated with a reception, execution and termination of the emergency alert message, and wherein the host transports the generated state information to the data broadcasting associated application.

To further achieve these and other advantages and in accordance with the purpose of the present invention, a broadcasting receiver according to the present invention includes a data broadcasting associated application, a platform downloading and installing the data broadcasting associated application therein, and a host receiving an emergency alert message transmitted from a broadcasting station, wherein if the emergency alert message is received, the host generates a platform based emergency alert message including information on the received emergency alert message and currently viewed channel information, wherein the host transports the generated platform based emergency alert message to the data broadcasting associated application, and wherein the host does not execute the received emergency alert message.

To further achieve these and other advantages and in accordance with the purpose of the present invention, a method of receiving and processing an emergency alert message in a broadcasting receiver based on a data broadcasting associated application platform according to the present invention includes the steps of generating reception state information with reference to the received emergency alert message and then transporting the generated reception state information to a data broadcasting associated application, if a content included in the received emergency alert message instructs an execution of the emergency alert message, generating start state information, transporting the generated start state information to the data broadcasting associated application, and executing the emergency alert message, and if the executed emergency alert message is terminated, generating termination state information including intrinsic information for discriminating the terminated emergency alert message and information on a previously viewed channel to return to, transporting the generated termination state information to the data broadcasting associated application, and terminating the execution of the emergency alert message.

To further achieve these and other advantages and in accordance with the purpose of the present invention, a method of receiving and processing an emergency alert message in a broadcasting receiver based on a data broadcasting associated application platform according to the present invention includes the steps of in the host receiving the emergency alert message, generating a platform based emergency alert message including information on the received emergency alert message, currently viewed channel information and exceptional channel information for controlling a switching to an emergency broadcast channel and transporting the generated platform based emergency alert message to the data broadcasting associated application and in the data broadcasting associated application receiving the platform based emergency alert message, executing the emergency alert message in accordance with a content of the received platform based emergency alert message.

Additional advantages, objects, and features of the invention will be more readily apparent from consideration of the following detailed description relating to the accompanying drawings.

### ADVANTAGEOUS EFFECTS

In a broadcasting receiver and method of processing an emergency alert message according to one embodiment of the present invention, if an emergency alert message is received, if an execution of a received emergency alert message such as a channel switching and/or a message display is necessary, or if a currently executed emergency alert message is terminated, a host within an OCAP based interactive cable broadcasting receiver provides each state information to an OCAP application. Hence, the present invention is able to prevent abnormal operation of the OCAP application when the host executed the emergency alert message.

In a broadcasting receiver and method of processing an emergency alert message according to another embodiment of the present invention, if an emergency alert message is received, a host within an OCAP based interactive cable broadcasting receiver, in order to execute the emergency alert message not in a host but in an OCAP application, a host within an OCAP based interactive cable broadcasting receiver generates an OCAP emergency alert message based on the received emergency alert message and then provides the generated message to the OCAP application. Hence, it is able to prevent abnormal operation of the OCAP application which may take place while the emergency alert message is being processed in the host.

### BRIEF DESCRIPTION OF THE DRAWINGS

FIG. 1 is a conceptional diagram of a cable broadcasting network including a host and a cable card according to the present invention;

FIG. 2 is a block diagram of an interactive cable broadcasting receiver according to one embodiment of the present invention;

FIG. 3 is a block diagram of a hardware resource in a cable broadcasting receiver shown in FIG. 2 according to one embodiment of the present invention;

FIG. 4 is a diagram of a syntax structure for reception state information transmitted to a data broadcasting associated application in case of receiving an emergency alert message according to one embodiment of the present invention;

FIG. 5 is a diagram of a syntax structure for start state information transmitted to a data broadcasting associated application in case of executing a received emergency alert message according to one embodiment of the present invention;

FIG. 6 is a diagram of a syntax structure for termination state information transmitted to a data broadcasting associated application in case of terminating a received emergency alert message according to one embodiment of the present invention;

FIG. 7 is a flowchart for a method of processing an emergency alert message in a host according to a first embodiment of the present invention;

FIG. 8 is a diagram of a syntax structure for an emergency alert message transmitted to a data broadcasting associated application for an emergency alert message processing according to one embodiment of the present invention; and

FIG. 9 is a flowchart for a method of processing an emergency alert message of a data broadcasting associated application according to a second embodiment of the present invention.

### BEST MODE FOR CARRYING OUT THE INVENTION

The configuration and operation of the embodiments of the present invention will be described with reference to the accompanying drawings. The configuration and operation of the present invention shown in the drawings and described hereinafter will be described in at least one embodiment, without limiting the spirit and scope of the present invention.

In addition, although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meanings of each term lying within.

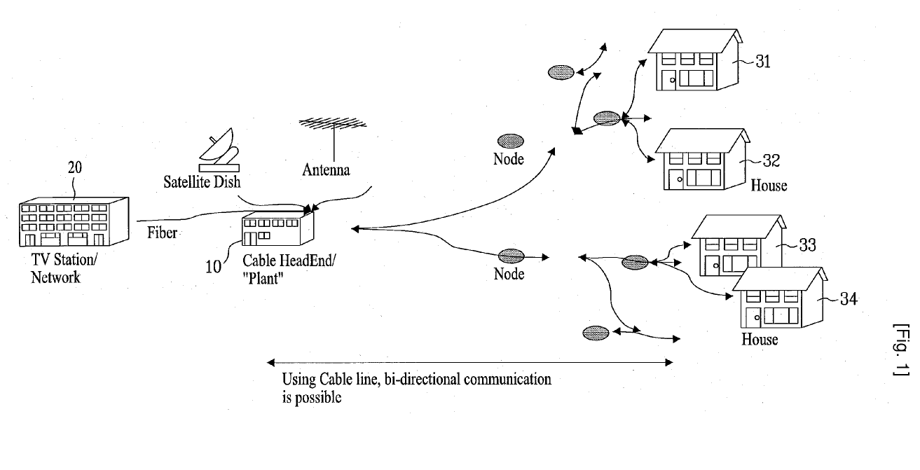

FIG. 1 is a conceptional diagram of a cable broadcasting network between a cable broadcasting receiver and a headend according to the present invention.

Referring to FIG. 1, a headend/plant 10 receives a broadcast signal via a television broadcasting station 20, a satellite, an antenna and the like and then delivers the received broadcast signal to a plurality of cable broadcasting receivers 31 to 34 via a cable network including nodes.

And, the cable broadcasting receiver and the headend/plant can exchange various data including data broadcasting associated application and the like via a cable network infrastructure capable of transferring data bi-directionally.

Moreover, the cable broadcasting receiver includes a detachable cable card.

The present invention employs a cable broadcasting receiver to explain its embodiment. In this case, the cable broadcasting receiver includes both OOB QPSK modem and DOCSIS (data over cable service interface specifications) modem and supports DSG (DOCSIS settop gateway).

And, the present invention employs a cable broadcasting receiver mounted with OCAP for an interactive data broadcasting service to explain its embodiment.

Data broadcasting is a service that various additional informations are usable as well as conventional A/V (audio/video) broadcasting (or TV program). The additional information can include the additional information associated with a currently displayed TV program (e.g., program introduction, performer profile, etc.) or the additional information irrelevant to a currently displayed TV program (e.g., news information, stock market information, weather information, travel information, etc.).

In case that a bi-directional data service is available, viewers can use bi-directional services such as home shopping, home banking, games, life information, entertainments, education, and the like through a simple manipulation of a remote controller. And, the data service corresponds to an application and is implemented using OCAP loaded in a broadcasting receiver.

### First Embodiment

A first embodiment of the present invention is characterized in securing a normal operation of a data broadcasting associated application is secured in a manner of enabling an emergency alert message to be processed in a host and enabling each state information to be provided to the data broadcasting associated application.

For instance, in case of receiving an emergency alert message, a host provides state information of the received emergency alert message to a data broadcasting associated application.

In case that a channel change and/or a message display is included in contents of the emergency alert message received by the host, state information associated with the contents is provided to the data broadcasting associated application by the host.

If the emergency alert message currently executed in the host is terminated, the host provides state information associated with the terminated message to the data broadcasting associated application.

Thus, the normal operations of the data broadcasting associated application can be secured.

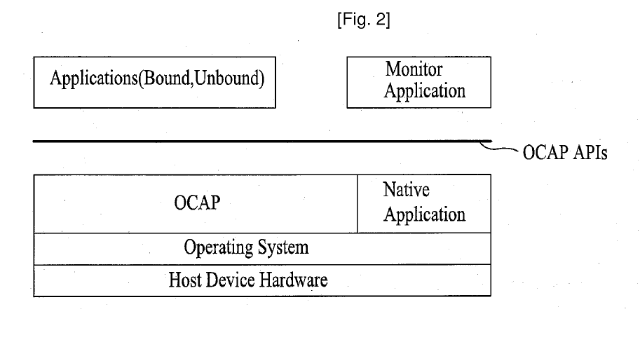

FIG. 2 is a block diagram of an OCAP based cable broadcasting receiver according to one embodiment of the present invention.

Referring to FIG. 2, an OCAP based cable broadcasting receiver according to one embodiment of the present invention includes a plurality of applications, an OCAP, an operating system, and a hardware resource. And, application program interfaces (APIs) exist between the OCAP and the applications.

The OCAP is a platform of a data broadcasting associated application adopted by an open cable system and provides a high-level API and service to a corresponding application using the hardware resource and the operating system.

The OCAP can include an execution engine and a presentation engine. The execution engine interprets and executes an application written in Java, while the presentation engine interprets and executes an application written in HTML. For instance, OCAP-J (Java) application is executed by the execution engine.

The application can be divided into broadcasting associated applications and native applications.

The data broadcasting associated applications use the API to utilize the hardware resource. In particular, instead of handling the hardware resource directly, all the data broadcasting associated applications maintains compatibility by enabling the hardware resources to be used through the API only. For the compatibility of the data broadcasting associated applications, the OCAP separates the data broadcasting associated applications from the hardware resources.

In this case, the data broadcasting associated applications indicate software operative using the execution environment specified by OCAP and the API. So, the data broadcasting associated application can be called an OCAP application.

The OCAP application types can be categorized into a bound application (channel inter-connective) and an unbound application (channel non-inter-connective).

The bound application is an application associated with or bound by a currently tuned channel and includes a game, an information service or the like for example. In this case, when a channel switching takes place and if there is no association with a newly tuned channel, the bound application should be terminated. In particular, when an application starts on a specific channel and if it is switched to a different channel, a corresponding application is terminated.

The unbound application is an application that is not bound by a special channel and includes a monitor application, a VOD (video on demand) application, an EPG (electronic program guide) application, an e-mail application, a chatting application, a game application, a web browser application, a PVR (personal video recorder) application or the like for example. In particular, the unbound application is downloaded in booting a broadcasting receiver and is then stored. And, the unbound application starts or ends regardless of a viewing channel.

The monitor application is a sort of service operating software that uses an API defined in the OCAP standard. The monitor application is capable of adjusting a start and end of a different application. Namely, the monitor application is a special unbound application prepared for a purpose of a cable broadcasting service provider and is provided with an API (e.g., receiver rebooting, error report, etc.) usable by the monitor application only. The monitor application is capable of coordinating collisions between various applications for a receiver resource such as a memory and the like and is able to exercise a priority control power for functions of almost all receivers.

And, the monitor application is capable of controlling a function of channel management and a function of a cable card. In particular, the monitor application basically controls a basic channel switching and operation in a host having a cable card inserted therein. Moreover, the monitor application, to which applications for TV driving or other additional services (EPG, VOD) are downloadable, is capable of executing the downloaded applications.

For instance, if a channel switching key inputted from an input device such as a remote controller is sent to an OCAP in a host in a data broadcasting mode, a data broadcasting associated application for managing channels, e.g., a monitor application executes state changes of various different applications associated with the channel switching in accordance with the channel switching key received from the host and a pause or termination of a bund application dedicated to a corresponding channel.

Meanwhile, the native application shown in FIG. 2 receives a digital broadcast signal, demultiplexes the received digital broadcast signal into video information, audio information, other broadcast programs information (EPG) and the like, and performs general functions to implement the demultiplexed information on a device. Namely, the native application is the application associated with executions of basic functions and is loaded in the broadcasting receiver prior to shipment.

And, the hardware resource is called a host device hardware and mainly includes a host and a cable card.

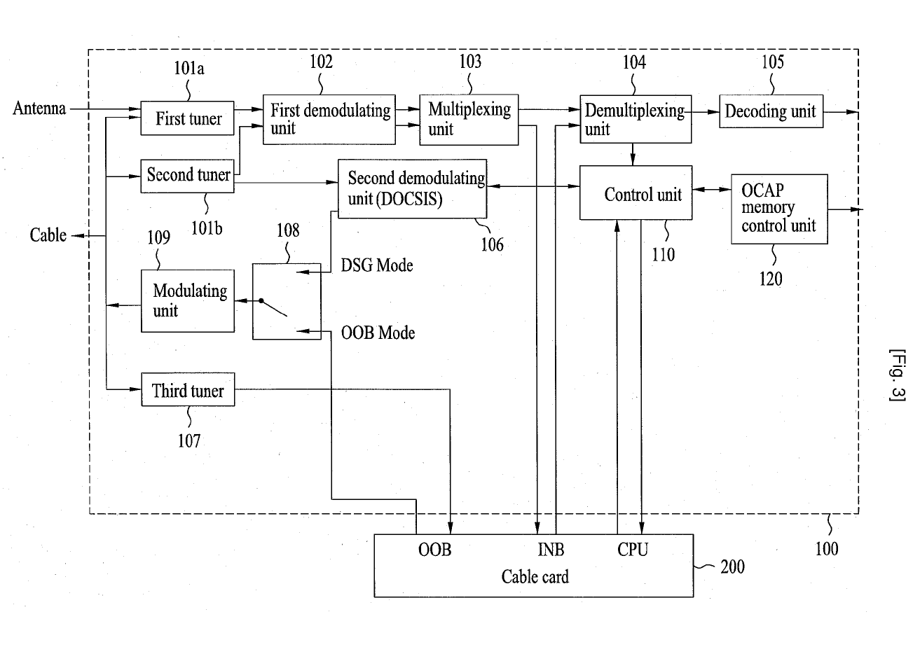

FIG. 3 is a block diagram of a hardware resource according to one embodiment of the present invention.

Referring to FIG. 3, a hardware resource according to one embodiment of the present invention includes a host 100 and a cable card 200 detachably inserted in the host 100.

The host 100 is capable of receiving cable broadcasting only or receiving at least one of cable broadcasting, terrestrial broadcasting and satellite broadcasting. The host 100 shown in FIG. 3 considers an example of receiving at least one of cable broadcasting, terrestrial broadcasting and satellite broadcasting.

The bi-direction communication system between a cable broadcasting receiver and a headend can be categorized into two kinds of systems, an OOB (out of band) system and a DSG (DOCSIS settop gateway) system. So, a viewer is able to select and view a specific program via a host using one of the two systems. A viewer is able to directly participate in a broadcast program or to select and view necessary information. And, a data broadcasting service can be provided via the OOB/DSG system.

The host 100, as shown in FIG. 3, can include a first tuner 101a, a second tuner 101b, a first demodulating unit 102, a multiplexing unit 103, a demultiplexing unit 104, a decoding unit 105, a second demodulating unit (DOCSIS) 106, a third tuner 107, a switching unit 108, a modulating unit 109, a control unit 110, and an OCAP memory control unit 120.

And, the cable card 200 includes a single card (S-card) capable of processing a single stream or a multi-card (M-card) capable of processing multi-stream.

The first tuner 101a is tuned to a specific channel frequency in terrestrial A/V (audio/video) broadcasting transmitted via antenna or cable A/V broadcasting transmitted by in-band through a cable only and then outputs the tuned signal to the first demodulating unit 102.

Since the terrestrial broadcasting differs from the cable broadcasting in transmission system, the first demodulating unit 102 is able to perform different demodulating processes on the different transmission type signals, respectively.

For instance, demodulation is carried out on a terrestrial A/V broadcast, which is modulated and transmitted by VSB (vestigial sideband modulation) scheme, by inverse VSB modulation. And, demodulation is carried out on a cable A/V broadcast, which is modulated and transmitted by QAM (quadrature amplitude modulation) scheme, by inverse QAM.

The signal demodulated by the first demodulating unit 102 is outputted in a stream form via the multiplexing unit 103. In doing so, if there exist a plurality of in-band tuners capable of receiving cable A/V broadcasting, if different channels are simultaneously tuned by a plurality of the in-band tuners, respectively, and if a signal is a multi-stream demodulated by each demodulating unit, the multi-stream is multiplexed by the multiplexing unit 103 and then outputted.

If a signal demodulated by the first demodulating unit 102 is a terrestrial broadcast stream, the demodulated stream is outputted to the demultiplexing unit 104 via the multiplexing unit 103. If a signal demodulated by the first demodulating unit 102 is a cable broadcast stream, the demodulated stream is outputted to the demultiplexing unit 104 via the multiplexing unit 103 and the cable card 200 inserted in a slot.

In this case, the cable card 200 includes a conditional access (CA) system for copy prevention and conditional access to higher value-added broadcast contents and can be called a POD (point of deployment) module as well.

In particular, if a single-stream or multi-stream outputted from the multiplexing unit 103 is scrambled, the cable card 200 descrambles the corresponding stream and then outputs the descrambled stream to the demultiplexing unit 104.

If the cable card 200 is not inserted, a single-stream or multi-stream demodulated by the first demodulating unit 102 is directly outputted to the demultiplexing unit 104. In this case, since it is unable to descramble the scrambled cable broadcast, a viewer is unable to view the scrambled cable broadcast normally.

The demultiplexing unit 104 separates the multiplexed broadcast stream into an audio stream, a video stream and a data stream and then outputs the separated streams to the corresponding decoding unit 105. So, the decoding unit 105 can include an audio decoder, a video decoder, and a data decoder.

In particular, the audio stream demultiplexed by the demultiplexing unit 104 is decoded by the audio decoder, the video stream demultiplexed by the demultiplexing unit 104 is decoded by the video decoder, and the data stream demultiplexed by the demultiplexing unit 104 is decoded by the data decoder.

The second tuner 101b is tuned to a specific channel frequency in data broadcasts transmitted via a cable by DSG and then outputs a corresponding signal to the second demodulating unit 106. The second demodulating unit 106 demodulates the DSG type data broadcast and then outputs the demodulated broadcast signal to the control unit 110.

The third tuner 107 is tuned to a specific channel frequency for a downlink data broadcast transmitted by OOB through a cable and then outputs the corresponding signal to the cable card 200.

In case that bi-directional communication is possible between the headend and the cable broadcasting receiver, uplink informations (e.g., pay program subscription, diagnosis information of host, etc.) transmitted to the headend from the cable broadcasting receiver can be transmitted by OOB or DSG. So, the cable broadcasting receiver according to the present invention can include the switching unit 108 capable of transmitting information by selecting either the OOB or the DSG.

In the OOB system, user information or system diagnosis information is outputted to the modulating unit 109 via the cable card 200 and the switching unit 1008. The modulating unit 109 modulates the corresponding output signal by QPSK (quadrature phase shift keying) modulation scheme and then transfers the modulated signal to the head and via the cable.

If broadcast information of user is transmitted by the DSG, the corresponding information is outputted to the modulating unit 109 via the switching unit 108. The modulating unit 109 modulates the information by QAM-16 (quadrature amplitude modulation-16). The modulated signal can be then transmitted to the headend via the cable.

Meanwhile, an emergency alert message [cable_emergency_alert( )] is defined by MPEG-2 table format to be compatible with MPEG-2 transport. The corresponding table is divided into at least one section unit and then transported in a transport packet form via in-band and OOB.

If the cable card is inserted in the host, an emergency alert message, which is tablized by SI protocol and transported by OOB, is outputted to the cable card 200 via the third tuner 107. The cable card 200 parses the received emergency alert message and then outputs the parsed message to the control unit 110.

Otherwise, if the cable card 200 is not inserted in the host, an emergency alert message, which is tablized by PSIP protocol and transported by in-band, is demultiplexed by the demultiplexing unit 104 without out passing through the cable card 200 and then outputted to the control unit 110.

The control unit 110 outputs the emergency alert message received via in-band or OOB to the OCAP memory control unit 120 and also forces tuning to an emergency broadcast channel in accordance with contents contained in the received emergency alert message or outputs the contents of the received emergency alert message in a text form to a screen. In a method of displaying the message, a text type emergency alert content is scrolled on a screen to be displayed. Alternatively, in a method of displaying the message, the corresponding content is outputted in an audio form. According to one embodiment of the present invention, the message is displayed on the screen in the text form. Optionally, the audio outputting method is applicable to the present invention as well.

If the emergency alert message is received from the control unit 110, if a channel change and/or a text type message output is contained in the content of the inputted emergency alert message, or if the emergency alert message currently processed by the control unit 110 is terminated, the OCAP memory control unit 120 provides each state information to the OCAP application.

Operations of the control unit 110 and the OCAP memory control unit 120 can include any one of hardware, firmware, middleware, and software or include any combination of at least two thereof. Moreover, the control unit 110 can play a role as the OCAP memory control unit 110. In this case, the OCAP memory control unit 120 can be omitted.

The OCAP applications, the native application, the OCAP middleware, the APIs, the operating system and other necessary softwares, which are shown in FIG. 2, are stored in a memory (not shown in the drawing) and are executed if a power of the broadcasting receiver is turned on or if a request is made by another application or a user.

For clarity of description, state information provided to the OCAP application in case of receiving an emergency alert message is named reception state information OCAP_EAS_Receive_report( ), state information provided to the OCAP application in case of needing a channel switching and/or a message output is named start state information OCAP_EAS_Start_report( ), and state information provided to the OCAP application in case of terminating processing of an emergency alert message is named termination state information OCAP_EAS_Terminate_report( ).

Embodiments of the state information provided to the OCAP application in accordance with the above cases are explained as follows.

1) Case of Receiving Emergency Alert Message

If an emergency alert message is received by a host via in-band or OOB, an OCAP memory control unit 120 within the host generates reception state information on an emergency alert message with reference to the received emergency alert message and then transports the generated reception state information to an OCAP application. Thus, the OCAP application is able to recognize that a channel switching and/or a message display may take place in the future. And, the OCAP application can make preparations if necessary.

The reception state information, which should be transported to the OCAP application, can include an event ID, a sequence number, a priority of an emergency alert message for deciding a presence or non-presence of a channel switching or a message display, an originator code, and the like.

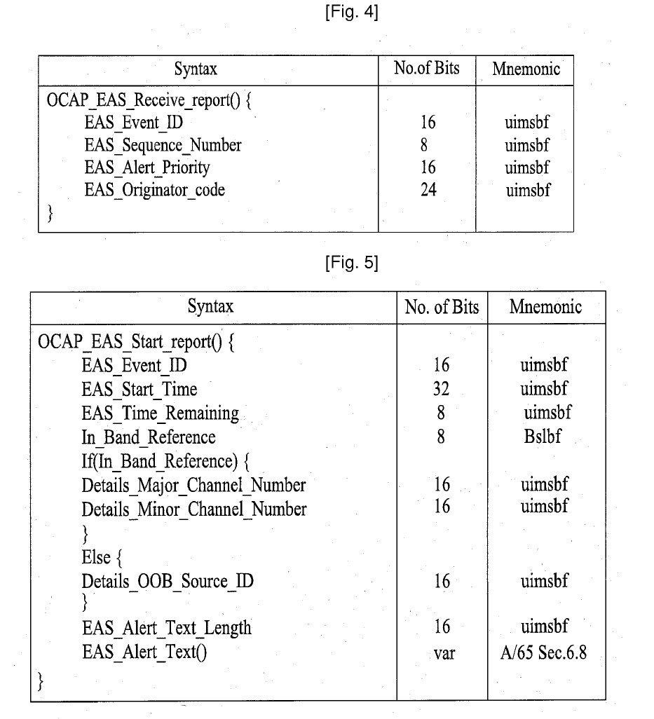

FIG. 4 is a diagram of a syntax structure for reception state information OCAP_EAS_Receive_report( ) transported to an OCAP application from a host in case that an emergency alert message is received by the host within a broadcasting receiver according to one embodiment of the present invention.

Referring to FIG. 4, reception state information OCAP_EAS_Receive_report( ) includes an event ID (EAS_Event_ID) field, a sequence number (EAS_Sequence_number) field, a priority (EAS_Alert_Priority) field, and an originator code (EAS_Originator_Code) field.

The EAS_Event_ID field designates the particular EA event. Each time a new EAS (Emergency Alert System) message is distributed throughout the cable system, a new EAS_Event_ID shall be assigned.

The EAS_Sequence_number filed shall be incremented by 1 modulo 32 when any change in the information carried in the cable_emergency_alert( ) message is made.

The EAS_Alert_priority field designates a priority of an emergency alert. A processing of the received emergency alert message is decided in accordance with a value of the EAS_Alert_priority field.

In particular, whether to unconditionally ignore the received emergency alert message, whether to ignore the received emergency alert message on a specific condition only, whether to force tuning to emergency broadcast channel (details channel) included in the received emergency alert message, and the like are decided.

For instance, if the EAS_Alert_priority field value is equal to or smaller than 11, there is no change into the emergency broadcast channel. Instead, by displaying information on the received emergency alert message in a text form on the screen, a viewer is informed of the emergency situation. If the EAS_Alert_priority field value is 15, a viewer is enabled to view an emergency broadcast in a manner that a currently viewed channel is forced to switch to an emergency broadcast channel included in the emergency alert message. The above numerical values are just exemplary, which does not limit the scope of the appended claims and their equivalents.

The EAS_Originator_Code field designates the entity that originally initiated the activation of the EAS.

Once the reception state information shown in FIG. 4 is transported to the OCAP application from the host, the OCAP application waits for start state information OCAP_EAS_Start_report( ), as shown in FIG. 5, and is able to take various actions in preparation for a channel switching or a message display that may happen in the future.

2) Case that Channel Switching and/or Message Display is Necessary for Processing Emergency Alert Message (EAM)

As mentioned in the foregoing description, whether a switching to an emergency broadcast channel and/or a message display is necessary can be known by the EAS_Alert_priority field value of the received emergency alert message. In this case, the message display means that an emergency alert content is displayed in a text form. According to one embodiment of the present invention, the text type emergency alert content is displayed in a manner of being scrolled on a portion o a screen.

In case that a channel switching to an emergency broadcast channel and/or a message display is necessary, a host of the present invention enables an OCAP application to normally operate by transporting start state information to the OCAP application. In particular, the host transports the start state information to the OCAP application and then starts a processing of a received emergency alert message.

The start state information, which needs to be transported to the OCAP application from the host, may include Event ID, start time & remaining time information, information on emergency broadcast channel to switch, information on message to be scrolled, and the like.

FIG. 5 is a diagram of a syntax structure for start state information OCAP_EAS_Start_report( ) transported to the OCAP application in case that a channel switching and/or a message display is necessary for processing a received emergency alert message according to one embodiment of the present invention.

Referring to FIG. 5, the start state information OCAP_EAS_Start_report( ) includes an event ID (EAS_Event_ID) field, a start time (EAS_Start_Time) field, a remaining time (EAS_Time_Remaining) field, a band information (In_Band_Reference) field indicating a band of an emergency broadcast channel to be switched, a channel number field indicating an emergency broadcast channel number according to a value of the In_Band_Reference field, a length (EaS_Alert_Text_Length) field indicating a text length to be scrolled, and a text (EAS_Alert_Text) field including a text to be scrolled.

The EAS_Event_ID field has the same meaning of the former EAS_Event_ID field explained in FIG. 4. In this case, the EAS_Event_ID field indicates which EAS needs a channel switching and/or a message display.

The EAS_Start_Time field designates the start time of this alert event as the number of seconds for example.

The EAS_Time_Remaining field designates the time remaining in the emergency alert message and can be set to a unit of 0˜120 seconds. In this case, the EAS_Time_Remaining field value is 0, a value of zero shall indicate an alert message period of indefinite duration.

The In_Band_Reference field designates whether an emergency broadcast channel to switch to is in-band or out-of-band (OOB).

If the emergency broadcast channel to switch to is in-band, an emergency broadcast channel number to switch to is indicated by fields Details_Major_Channel_Number and Detials_Minor_Channel_Number. For instance, if a band of an emergency broadcast channel to switch to is OOB (i.e., if a value of the field In_Band_Reference is 1), a channel is switched using a major channel number and a minor channel number.

In other words, in case that an emergency broadcast channel to switched is in-band, the Details_Major_Channel_Number and Detials_Minor_Channel_Number fields indicate major and minor channel numbers of an emergency broadcast channel to be tuned to.

And, the Detail_OOB_Source_ID field designates a source ID of a virtual channel for an emergency broadcast channel to be tuned to if an emergency broadcast channel to switch to is OOB. In this case, the source ID refers to a virtual channel described in OOB SI. If OOB SI is not valid, the Detail_OOB_Source_ID field is ignored.

Thus, the host transports OOB source ID or major/minor channel number to the OCAP application in accordance with a value of the EAS_Event_ID field and a value of the band information field of the emergency broadcast channel to switch to.

The EAS_Alert_Text_Length field defines a total length of the EAS_Alert_Text( ) field that right follows the EAS_Alert_Text_Length field. If a value of the EAS_Alert_Text_Length field is set to 0, it indicates that the EAS_Alert_Text( ) field is not included in an emergency alert message.

A data structure of the EAS_Alert_Text( ) field includes a multiple_string_structure( ) field that indicates a textual description of an emergency alert. A text type emergency information content obtained from parsing the alert_text( ) field is scrolled right to left on an upper end of a screen for example.

Having received the start state information OCAP_EAS_Start_report( ) shown in FIG. 5, the OCAP application controls a currently executed application to enable the host to normally process the emergency alert message.

For instance, while an application news is displayed in a text form on a portion of a screen, if a picture of the news interrupts a display of an emergency alert message to be processed by a host, it is able to pause or terminate the news application that is being displayed.

3) Case of Terminating Emergency Alert Message in Progress of Processing

If an emergency alert message having been executed in a situation that forcible switching to an emergency broadcast channel has taken place is terminated, a channel should be switched to an original channel having been viewed by a user.

In this case, a host of the present invention transports termination state information, which includes information on a channel to return to, to the OCAP application, thereby enabling the OCAP application to normally operate.

The termination state information, which should be transported to the OCAP application from the host, can include Event_ID, information on an original channel to return to, and the like.

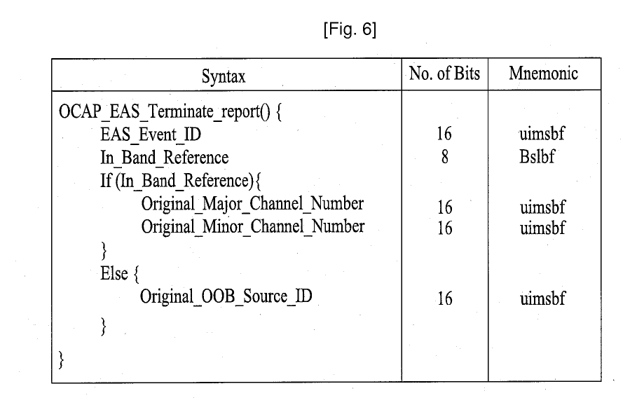

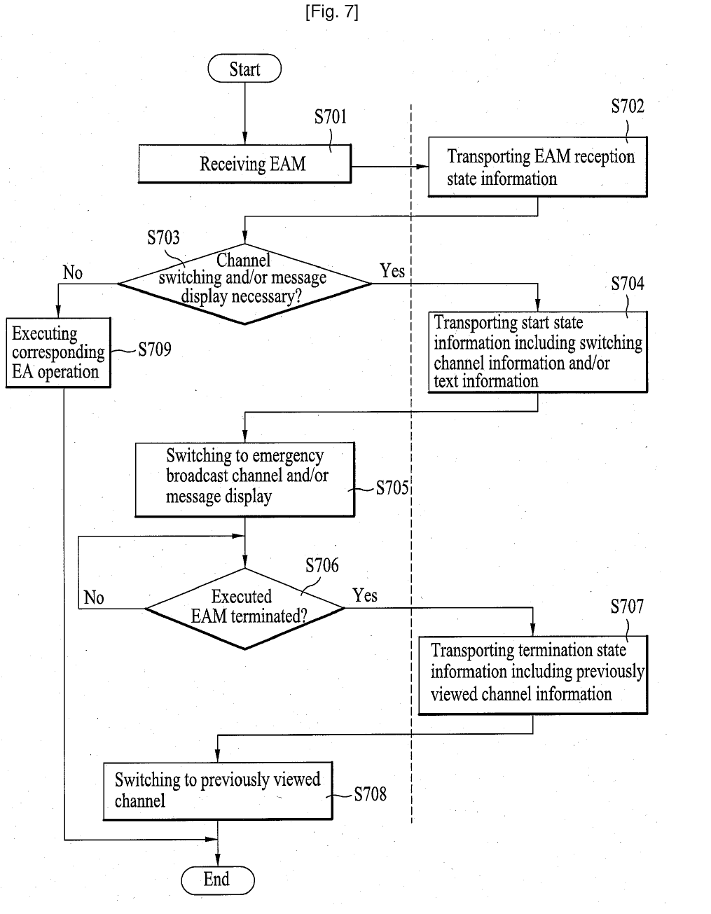

FIG. 6 is a diagram of a syntax structure for termination state information OCAP_EAS_Terminate_report( ) transmitted to the OCAP application in case of terminating a received emergency alert message according to one embodiment of the present invention.

Referring to FIG. 6, termination state information OCAP_EAS_Terminate_report( ) includes an event ID (EAS_Event_ID) field, a band information In_Band_Reference field indicating a band of channel to return to, and a channel information field indicating information on an original broadcast channel to return to in accordance with a value of the In_Band_Reference field.

The EAS_Event_ID field has the same meaning of the former EAS_Event_ID field explained in FIG. 4 and indicates which EAS is terminated.

The In_Band_Reference field indicates an original channel to return to is an in-band channel or an OOB channel. For instance, if a value of the In_Band_Reference field is 1, it indicates that an original channel to return to is an in-band channel. If it is 0, it indicates that an original channel to return to is an OOB channel. Namely, if a value of the In_Band_Reference field is 1, a current channel is switched to a channel indicated by a major channel number and a minor channel number. If a value of the In_Band_Reference field is 0, a current channel is switched to a channel indicated by an OOB source ID field.

So, information on an original channel, to which a current channel is switched to if a value of the In_Band_Reference field is 1, is indicated by a Original_Major_Channel_Number field and a Original_Minor_Channel_Number field. Information on an original channel, to which a current channel is switched to if a value of the In_Band_Reference field is 0, is indicated by a Original_OOB_Source_ID field.

For this, the Original_Major_Channel_Number and Original_Minor_Channel_Number fields indicate major and minor channel numbers of an original in-band channel to return to if an emergency alert message is terminated (Indicates the major and minor channel number associated with an interrupted channel by EAS).

The Original_OOB_Source_ID field indicates the Source ID of a virtual channel associated with an interrupted OOB Source by EAS.

Namely, the host transports an OOB source ID to the OCAP application in case of an OOB channel in accordance with the EAS_Event_ID field and an originally viewed channel type. The host transports major and minor channel numbers to the OCAP application in case of an in-band channel in accordance with the EAS_Event_ID field and an originally viewed channel type.

FIG. 7 is a flowchart for a method of receiving and processing an emergency alert message according to a first embodiment of the present invention.

A left part of FIG. 7 shows an example of receiving and processing an emergency alert message in a host and a right part shows an example of state information transported to an OCAP application.

Referring to FIG. 7, if an emergency alert message is received (S701), a host transports reception state information, as shown in FIG. 4, to an OCAP application (S702).

The host checks whether a channel switching to an emergency broadcast channel and/or a message display is needed to process the received emergency alert message (S703).

If it is decided in the step S703 that the channel switching to the emergency broadcast channel and/or the message display is not needed, an emergency alert operation in accordance with a content of the received emergency alert message is carried out (S709).

If it is decided in the step S703 that the channel switching to the emergency broadcast channel and/or the message display is needed, start state information including information on an emergency broadcast channel to switch to and/or information on a text to be displayed, as shown in FIG. 5, is transported to the OCAP application (S704).

If the channel switching is needed, the host performs the channel switching to an emergency broadcast channel contained in the received emergency alert message. If information on a text to be scrolled is contained therein, an emergency alert content is scrolled in a text form on a preset portion of a screen (S705).

In doing so, the host checks whether an execution of the emergency alert message is terminated (S706). For instance, the host is able to check whether the currently executed emergency alert message is terminated or not with reference to EAS_Start_Time and EAS_Time_Remaining fields contained in the received emergency alert message.

If the termination of the executed emergency alert message is confirmed in the step S706, the host transports termination state information, as shown in FIG. 6, to the OCAP application (S707). In this case, in case of a state that it has been switched to the emergency broadcast channel, the termination state information includes information on an original channel to return to.

Subsequently, the host terminates the executed emergency alert message (S708). For instance, in case of a state that it has been switched to the emergency broadcast channel, it returns to an original channel currently viewed. If an emergency alert content is being displayed in a text form, a display of the emergency alert content is terminated.

As mentioned in the foregoing description so far, according to a first embodiment of the present invention, if an emergency alert message arrives at a host, the host performs a function such as a channel switching, a message display and the like in accordance with a priority value of the emergency alert message and also transports each state information to an OCAP application via a host program loaded in the host, e.g., an OCAP memory control unit 120.

Thus, normal operations of the OCAP application can be secured. If the host executed the emergency alert message without providing the information on the reception and execution of the emergency alert message to the OCAP application, it is unable to secure the normal operations of the OCAP application. This is because the OCAP application controls the channel switching and the like.

### Second Embodiment

A second embodiment of the present invention is characterized in providing state information of a received emergency alert message to a data broadcasting associated application to enable not a host but the data broadcasting associated application to execute the emergency alert message if the emergency alert message is received by the host. Hence, it is able to secure normal operations of the data broadcasting associated application.

To execute the second embodiment of the present invention, the interactive cable broadcasting receiver shown in FIG. 2 and the hardware resource shown in FIG. 3 are usable intact. As details for FIG. 2 and FIG. 3 are explained in the description of the first embodiment of the present invention, parts relevant to the second embodiment are explained but the rest is omitted in the following description.

First of all, the control unit 110 outputs an emergency alert message received via in-band or OOB to the OCAP memory control unit 120.

If the emergency alert message is inputted from the control unit 110, the OCAP memory control unit 120 generates information required for executing the emergency alert message in a data broadcasting associated application, e.g., an OCAP application and then transports the generated information to the OCAP application.

For clarity of the description of the present invention, the information necessary for the OCAP application to execute the emergency alert message is named an OCAP emergency alert message.

Operations of the control unit 110 and the OCAP memory control unit 120 can include any one of hardware, firmware, middleware, and software or include any combination of at least two thereof.

Moreover, the control unit 110 can play a role as the OCAP memory control unit 120. In this case, the OCAP memory control unit 120 can be omitted. In this case, the control unit 110 or the OCAP memory control unit 120 within the host just transports an OCAP emergency alert message to the OCAP application but does not actually process the emergency alert message.

The OCAP applications, the native application, the OCAP middleware, the APIs, the operating system and other necessary softwares, which are shown in FIG. 2, are stored in a memory (not shown in the drawing) and are executed if a power of the broadcasting receiver is turned on or if a request is made by another application or a user.

In the present invention, in order for an OCAP application to process an emergency alert message, an OCAP based application is newly added or an emergency alert message processing function can be added to a conventional OCAP application. In this case, the OCAP application for the emergency alert message processing can be downloaded from a headend via a broadcasting network or a communication network. Alternatively, the OCAP application for the emergency alert message processing can be downloaded via a different interface (e.g., USB interface) except the broadcasting network or the communication network or can be loaded in a broadcasting receiver prior to shipment.

The OCAP application for the emergency alert message forces tuning to an emergency broadcast channel in accordance with a content contained in an OCAP emergency alert message transported from a host or outputs a content of an emergency alert message in a text form to a screen. In this case, the forcible tuning to the emergency broadcast channel and the message display can be simultaneously carried out or either the forcible tuning or the message display can be executed only. A method for the message display can be carried out in a manner of scrolling a text type emergency alert content on a screen. Alternatively, a method for the message display can be carried out in a manner of outputting an emergency alert content in an audio form. According to one embodiment of the present invention, an emergency alert content is displayed in a text form on a screen. Alternatively, a method of outputting an emergency alert content in an audio form is applicable to the present invention.

The OCAP application is able to pause or terminate a currently executed different application to process a received OCAP emergency alert message.

Once an execution of an OCAP emergency alert message is ended, the OCAP application re-executes the paused or terminated application for the processing of the OCAP emergency alert message or switches an emergency broadcast channel to an original viewing channel.

For this, the OCAP emergency alert message can include an event ID, a sequence number, start time & remaining time information, priority information of an emergency alert message for deciding whether to execute a channel switching or a message display, information on an emergency broadcast channel to be forcibly switched, information on text to be displayed, and information on an original viewing channel to return to.

The OCAP emergency alert message can further include information for executing an emergency alert message in a specified area only.

The OCAP emergency alert message can further include exceptional channel information not to switch to an emergency broadcast channel in accordance with a currently viewed channel.

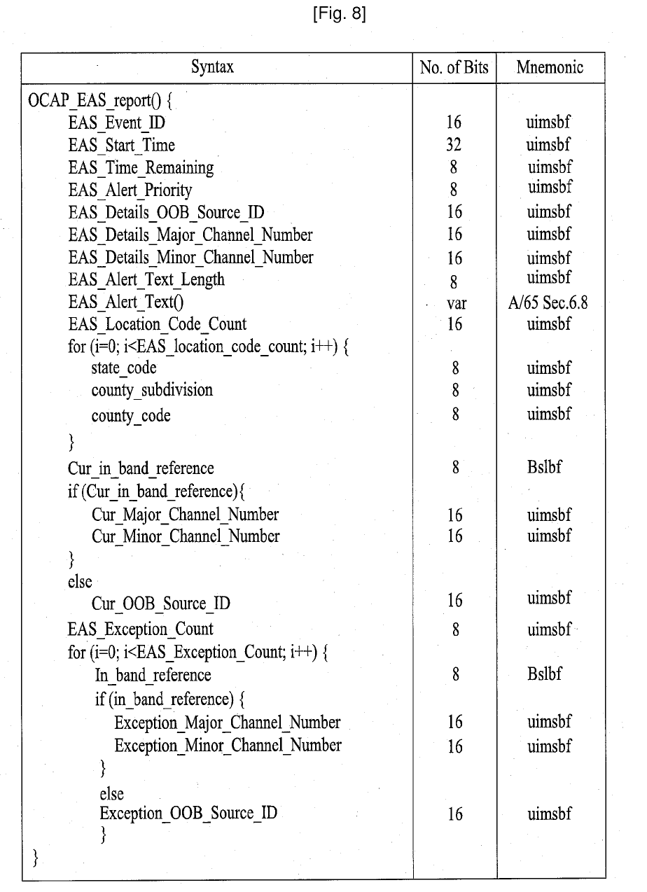

FIG. 8 is a diagram of a syntax structure for an OCAP emergency alert message OCAP_EAS_report( ) generated based on an emergency alert message received by a host within a broadcasting receiver according to one embodiment of the present invention. The generated OCAP emergency alert message is transported to an OCAP application and then the OCAP application executes the OCAP emergency alert message.

Referring to FIG. 8, in order for an OCAP application to switch to an emergency broadcast channel or to execute a message display, an OCAP emergency alert message OCAP_EAS_report( ) can include EAS_Event_ID field indicating an event ID, EAS_Alert_Priority field indicating a priority, EAS_Start_Time field indicating a start time, EAS_Time_Remaining field indicating a remaining time, EAS_Details_OOB_Source_ID field indicating an emergency broadcast channel number for OOB, EAS_Details_Major_Channel_Number field indicating an emergency broadcast major channel number for in-band, EAS_Details_Minor_Channel_Number field indicating an emergency broadcast minor channel number for in-band, a length (EAS_Alert_Text_Length) field indicating a text length to be scrolled, and a text (EAS_Alert_Text) field indicating a text to be scrolled.

In order for an OCAP application to execute an emergency alert message in a specified area only, the OCAP emergency alert message OCAP_EAS_report( ) can include EAS_Location_Code_Count field and an iterative statement that is iterated in accordance with the EAS_Location_Code_Count field. And, the iterative statement can include a first location (e.g., state_code) field, a second location (e.g., county_subdivision) field, and a third location (e.g., county_code) field.

In order to return to a previously viewed channel if a currently executed emergency alert message is terminated and to process an exceptional channel, the OCAP emergency alert message OCAP_EAS_report( ) can include Cur_in_band_reference field indicating a band of a currently viewed channel, Cur_Major_Channel_Number field indicating a current in-band major channel number to return to, Cur_Minor_Channel_Number field indicating an in-band current minor channel number to return to, and Cur_OOB_Source_ID field indicating an OOB current channel number to return to. In this case, either the Cur_Major_channel_Number/Cur_Minor_channel_Number fields or the Cur_OOB_Source_ID field can be included in accordance with a value of the Cur_in_band_reference field.

In order not to switch to an emergency broadcast channel in accordance with a currently viewed channel, the OCAP emergency alert message OCAP_EAS_report( ) can include EAS_Exception_Count field indicating a count of exceptional channels restricting a switching to an emergency broadcast channel and an iterative statement iterated in accordance with a value of the EAS_Exception_count field.

The iterative statement can include In_band_reference field indicating a band of an exceptional channel to restrict an emergency broadcast channel switching, Exception_Major_Channel_Number field indicating an in-band exceptional major channel number, Exception_Minor_Channel_Number field indicating an in-band exceptional minor channel number, and Exception_OOB_Source_ID field indicating an OOB exceptional channel number.

In this case, either the Exception_Major_Channel_Number/Exception_Minor_Channel_Number fields or the Exception_OOB_Source_ID field can be included in accordance with a value of the In_band_reference field.

In the above configuration shown in FIG. 8, the EAS_Event_ID field indicates a specific emergency alert (EA) event. Each time a new EAS message is distributed throughout a broadcast receiver, a new EAS_Event_ID shall be assigned.

The EAS_Start_Time field designates the start time of this alert event as the number of seconds.

The EAS_Time_Remaining field designates the time remaining in the alert message as 0-120 seconds. In this case, when a value of the EAS_Time_Remaining field is zero, it shall indicate an alert message period of indefinite duration.

The EAS_Alert_priority field designates a priority of an emergency alert. A processing of the received OCAP emergency alert message is decided in accordance with a value of the EAS_Alert_priority field.

In particular, whether to unconditionally ignore the received OCAP emergency alert message, whether to ignore the received OCAP emergency alert message on a specific condition only, whether to force tuning to emergency broadcast channel (details channel) included in the received OCAP emergency alert message, and the like are decided.

For instance, if the EAS_Alert_priority field value is equal to or smaller than 11, there is no change into the emergency broadcast channel. Instead, by displaying information on the received OCAP emergency alert message in a text form on the screen, a viewer is informed of the emergency situation. If the EAS_Alert_priority field value is 15, a viewer is enabled to view an emergency broadcast in a manner that a currently viewed channel is forced to switch to an emergency broadcast channel included in the OCAP emergency alert message. The above numerical values are just exemplary, which does not limit the scope of the appended claims and their equivalents.

The EAS_Details_OOB_Source_ID designates a source ID of a virtual channel for an emergency broadcast channel to be tuned to if an emergency alert message is transported by OOB. In this case, the source ID refers to a virtual channel described in OOB SI. If OOB SI is not valid, the field EAS_Details_OOB_Source_ID is ignored.

The EAS_Details_Major_Channel_Number and EAS_Details_Minor_Channel_Number fields indicate major and minor channel numbers of an emergency broadcast channel to be tuned to when an emergency alert message is transported by in-band.

The EAS_Alert_Text_Length field defines a total length of the EAS_Alert_Text( ) field that right follows the EAS_Alert_Text_Length field. If a value of the EAS_Alert_Text_Length field is set to 0, it indicates that the EAS_Alert_Text( ) field is not included in an emergency alert message.

A data structure of the EAS_Alert_Text( ) field includes a multiple_string_structure( ) field that indicates a textual description of an emergency alert. A text type emergency information content obtained from parsing the EAS_Alert_text( ) field is scrolled right to left on an upper end of a screen for example.

The EAS_Location_Code_Count field indicates a count of locations to which an emergency alert message shall be delivered. ‘FOR’ iterative statement, which is executed as many as a count of locations to which an emergency alert message shall be delivered (i.e., a value of the EAS_Location_Code_Count field), follows the EAS_Location_Code_Count field.

At least one of first to third location fields within the ‘FOR’ iterative statement is set to a code value for discriminating a location to which an emergency alert message is delivered. In this case, values set in the first to third location fields are set suitable for a preset administrative district.

In the present invention, an administrative district unit is determined in order of first location (state_code) field>second location (county_subdivision) field>third location (county_code) field for example.

In particular, it is able to specify a location, to which an emergency alert message shall be delivered, in a manner of discriminating administrative districts from a larger one to a smaller one in order of the first to third location fields and then setting a code value indicating the corresponding district.

The Cur_in_band_reference field indicates information on a band to return to if a currently executed emergency alert message is terminated. According to one embodiment of the present invention, if a value of the Cur_in_band_reference field is 1, information on an original channel to return to is marked in the Cur_Major_Channel_Number and Cur_Minor_channel_Number fields. If the value is 0, the information is marked in the Cur_OOB_Source_ID field.

Namely, the Cur_Major_Channel_Number and Cur_Minor_channel_Number fields indicate the major and minor channel numbers associated with an interrupted in-band channel by EAS, respectively. The Cur_OOB_Source_ID field indicates the Source ID of a virtual channel associated with an interrupted OOB Source by EAS.

The EAS_Exception_Count field indicates a count of exceptional fields that will restrict a switching to an emergency broadcast channel even if the emergency broadcast channel is transmitted. And, ‘FOR’ iterative statement following the EAS_Exception_Count field includes exceptional channel information for restricting a switching to an emergency broadcast channel.

In particular, if a currently viewed channel is included in the exceptional channel information within the ‘FOR’ iterative statement, even if a priority field value instructs a switching to an emergency broadcast channel, an OCAP application does not perform a switching to an emergency broadcast channel. In other words, if current channel information is included in exceptional channel information, an OCAP application does not perform such an emergency alert message processing as a switching to an emergency broadcast channel.

For instance, if a currently viewed channel is CNN, assuming that CNN is included in the exceptional channel information, if emergency broadcast channel information is included in a received OCAP emergency alert message and if a priority field value instructs a switching to an emergency broadcast channel, the switching to the emergency broadcast channel does not take place.

The ‘FOR’ iterative statement iterated as many as a value of the EAS_Exception_Count field includes In_band_reference field and Exception_Major_Channel_Number/Exception_Minor_Channel_Number fields or Exception_OOB_Source_ID field in accordance with a value of the In_band_reference field.

The currently viewed channel information, i.e., the Cur_in_band_reference field, the Cur_Major_Channel_Number field, the Cur_Minor_Channel_Number field, and the Cur_OOB_Source_ID field are referred to for the processing for exception as well as for returning to a previously viewed channel after termination of an emergency alert message.

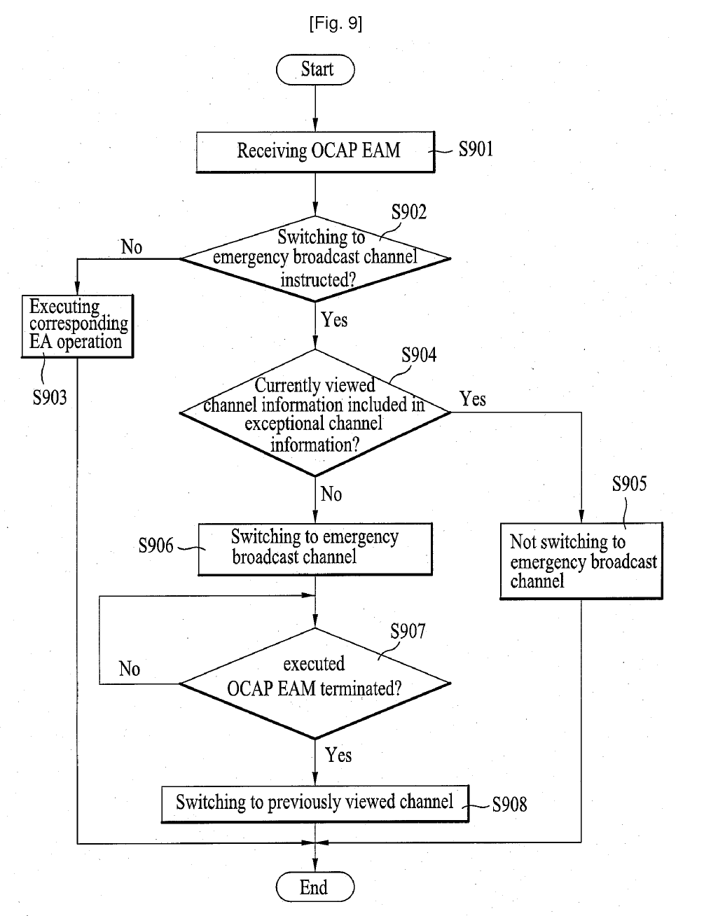

FIG. 9 is a flowchart for a method of processing an emergency alert message of a data broadcasting associated application according to a second embodiment of the present invention.

Referring to FIG. 9, if an emergency alert message is received via in-band or OOB, a host generates an OCAP emergency alert message, as shown in FIG. 8, based on the received emergency alert message and then transports the generated message to an OCAP application.

If the OCAP emergency alert message is received from the host (S901), the OCAP application whether a forcible tuning to an emergency broadcast channel is necessary with reference to a value of EAS_Alert_Priority field within the received OCAP emergency alert message (S902).

If it is decided in the step S902 that the forcible tuning to an emergency broadcast channel is not necessary, an emergency alert operation according to a content of the received OCAP emergency alert message is executed (S903). For instance, if a message display is necessary, an emergency alert content is scrolled in a text form on a preset portion of a screen with reference to EAS_Alert_Text_Length and EAS_Alert_Text( ) fields within the received OCAP emergency alert message.

Meanwhile, if it is decided in the step S902 that the forcible tuning to an emergency broadcast channel is necessary, it is checked whether currently viewed channel information is included in exceptional channel information (S904). For this, currently viewed channel information (Cur_Major_Channel_Number/Cur_Minor_Channel_Number fields, Cur_OOB_Source_ID field) within the received OCAP emergency alert message is compared to exceptional channel information (Exception_Major_Channel_Number/Exception_Minor_Channel_Number fields, Exception_OOB_Source_ID field).

If it is decided in the step S904 that the currently viewed channel information is included in the exceptional channel information, even if the value of the EAS_Alert_Priority field instructs a switching to an emergency broadcast channel, the switching to the emergency broadcast channel included in the OCAP emergency alert message is not executed (S905).

For instance, if a currently viewed channel is CNN, assuming that the CNN is included in the exceptional channel information, if emergency broadcast channel information ‘KBS’ is included in the received OCAP emergency alert message and even if the value of the EAS_Alert_Priority field instructs a switching to an emergency broadcast channel, the switching to the emergency broadcast channel ‘KBS’ is not carried out.

On the contrary, if it is decided in the step S904 that the currently viewed channel information is not included in the exceptional channel information, a switching to an emergency broadcast channel is executed with reference to EAS_Details_OOB_Source_ID field, EAS_Details_Major_Channel_Number/EAS_Details_Minor_Channel_Number fields within the received OCAP emergency alert message (S906).

Once the channel switching to the emergency broadcast channel is completed, it is checked whether the currently executed emergency alert message is terminated or not with reference to EAS_Start_Time and EAS_Time_Remaining fields included in the received OCAP emergency alert message (S907).

If the termination of the executed emergency alert message is confirmed in the step S907, a switching to a previously viewed channel is carried out with reference to currently viewed channel information (Cur_in_band_reference field, Cur_Major_Channel_Number/Cur_Minor_Channel_Number fields, and Cur_OOB_Source_ID field) within the received OCAP emergency alert message (S908).

As mentioned in the foregoing description, according to a second embodiment of the present invention, a host does not process an emergency alert message but an OCAP application for EAS processes an OCAP emergency alert message transported from the host. Thus, a malfunction or error of the OCAP application, which may be attributed to the emergency alert message processed by the host, can be prevented.

In the above-described embodiments of the present invention, a descrambling module is provided to a cable card which is detachably inserted in a host. In this case a broadcast signal from a broadcasting station (or headend) is descrambled by the descrambling module of the cable card and is then provided to a user.

Alternatively, according to a prescribed embodiment, a descrambling module is provided within a host without a cable card. And, a broadcast signal from a broadcasting station is descrambled by the descrambling module within the host and is then provided to a user. In this case, the descrambling module can be configured to be downloaded from the broadcasting station or the like. In particular, the descrambling module (or software CAS) downloaded from the broadcasting station or the like can be differently configured to be stored in a prescribed memory within the host.

For instance, the descrambling module can be downloaded in a manner of downloading a CA (conditional access) image from a headend after a security processor loaded in the host in advance is connected to a network.

Yet, it is to be understood that the difference in configuration does not change the scope of the appended claims and their equivalents.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A broadcasting receiver comprising:
a data broadcasting associated application;
a platform downloading and installing the data broadcasting associated application therein; and
a host receiving an emergency alert message transmitted from a broadcasting station,
wherein the host executes or terminates the emergency alert message in accordance with a content included in the received emergency alert message, wherein the host generates state information associated with a reception, execution and termination of the emergency alert message, and wherein the host transports the generated state information to the data broadcasting associated application.

2. The broadcasting receiver of claim 1, wherein if receiving the emergency alert message, the host generates reception state information including intrinsic information for discriminating the received emergency alert message and priority information for deciding whether to execute the received emergency alert message and then transports the generated reception state information to the data broadcasting associated application.

3. The broadcasting receiver of claim 1, wherein if the content included in the received emergency alert message instructs at least one of a switching to an emergency broadcast channel and a display of an emergency alert associated content, the host generates start state information including information for discriminating the emergency alert message to execute, time information for obtaining a start time and a remaining time, information on the emergency broadcast channel to switch to, and information on a message to display, transports the generated start state information to the data broadcasting associated application, and executes at least one of the switching to the emergency broadcast channel and the display of the emergency alert associated content.

4. The broadcasting receiver of claim 1, wherein if a currently executed emergency alert message is terminated, the host generates termination state information including information for discriminating the terminated emergency alert message and information on an original viewing channel to return to, transports the generated termination state information to the data broadcasting associated application, and terminates the execution of the emergency alert message.

5. A broadcasting receiver comprising:
a data broadcasting associated application;
a platform downloading and installing the data broadcasting associated application therein; and
a host receiving an emergency alert message transmitted from a broadcasting station,
wherein if the emergency alert message is received, the host generates a platform based emergency alert message including information on the received emergency alert message and currently viewed channel information, wherein the host transports the generated platform based emergency alert message to the data broadcasting associated application, and wherein the host does not execute the received emergency alert message.

6. The broadcasting receiver of claim 5, wherein the data broadcasting associated application executes the emergency alert message in accordance with a content of the platform based emergency alert message transported from the host.

7. The broadcasting receiver of claim 6, wherein the host transports the platform based emergency alert message in which exception channel information for controlling a switching to an emergency broadcast channel is further included to the data broadcasting associated application.

8. The broadcasting receiver of claim 7, wherein if the transported platform based emergency alert message instructs the switching to the emergency broadcast channel and if the currently viewed channel information is included in the exceptional channel information, the data broadcasting associated application does not execute the switching to the emergency broadcast channel.

9. The broadcasting receiver of claim 7, wherein if the transported platform based emergency alert message instructs the switching to the emergency broadcast channel and if the currently viewed channel information is not included in the exceptional channel information, the data broadcasting associated application executes the switching to the emergency broadcast channel.

10. The broadcasting receiver of claim 6, wherein if the executed emergency alert message is terminated, the data broadcasting associated application executes a switching to a previously viewed channel with reference to currently viewed channel information included in the platform based emergency alert message.

11. A method of receiving and processing an emergency alert message in a host of a data broadcasting associated application platform based broadcasting receiver, comprising the steps of:
generating reception state information with reference to the received emergency alert message and then transporting the generated reception state information to a data broadcasting associated application;
if a content included in the received emergency alert message instructs an execution of the emergency alert message, generating start state information, transporting the generated start state information to the data broadcasting associated application, and executing the emergency alert message; and
if the executed emergency alert message is terminated, generating termination state information including intrinsic information for discriminating the terminated emergency alert message and information on a previously viewed channel to return to, transporting the generated termination state information to the data broadcasting associated application, and terminating the execution of the emergency alert message.

12. The method of claim 11, wherein the reception state information includes at least one of intrinsic information for discriminating the received emergency alert message uniquely, identification information for identifying a content change of the received emergency alert message, priority information for deciding a degree of significance of the received emergency alert message, and entity information for discriminating an entity initially activating the received emergency alert message.

13. The method of claim 11, wherein the start state information includes intrinsic information for discriminating the emergency alert message to execute and time information for obtaining a start time and a remaining time and further includes at least one of information on an emergency broadcast channel to switch to in accordance with an execution content of the emergency alert message and information on a message to be displayed.

14. A method of receiving and processing an emergency alert message in a platform based broadcasting receiver including a host and a data broadcasting associated application, comprising the steps of:
in the host receiving the emergency alert message, generating a platform based emergency alert message including information on the received emergency alert message, currently viewed channel information and exceptional channel information for controlling a switching to an emergency broadcast channel;
in the host receiving the emergency alert message, transporting the generated platform based emergency alert message to the data broadcasting associated application; and
in the data broadcasting associated application, receiving the platform based emergency alert message, executing the emergency alert message in accordance with a content of the received platform based emergency alert message.

15. The method of claim 14, wherein in the executing step, if the received platform based emergency alert message instructs the switching to the emergency broadcast channel and if the currently viewed channel information is included in the exceptional channel information, the switching to the emergency broadcast channel is not executed.

16. The method of claim 14, wherein in the executing step, if the received platform based emergency alert message instructs the switching to the emergency broadcast channel and if the currently viewed channel information is not included in the exceptional channel information, the switching to the emergency broadcast channel is executed.

17. The method of claim 14, the executing step further comprising the step of if the executed emergency alert message is terminated, switching to a previously viewed channel with reference to the currently viewed channel information included in the received platform based emergency alert message.

18. The method of claim 14, wherein the emergency alert message information included in the platform based emergency alert message includes at least one of intrinsic information for discriminating the received emergency alert message, priority information for deciding whether to execute the received emergency alert message, time information for obtaining a start time and a remaining time, information on an emergency broadcast channel to switch to, and a content associated with an emergency alert to be displayed.

19. The method of claim 14, wherein the emergency alert message information included in the platform based emergency alert message further includes location information indicating a location where the emergency alert message will be executed.

20. The method of claim 14, wherein the platform is OCAP and wherein the data broadcasting associated application includes an OCAP application.
